(19) United States
(12) Patent Application Publication
(10) Pub. No.: US 2009/0157768 A1
(43) Pub. Date: Jun. 18, 2009

(54) COMPUTER SYSTEM AND DATA LOSS PREVENTION METHOD

(76) Inventors: Naoko Ichikawa, Yokohama (JP); Yuichi Taguchi, Sagamihara (JP); Masayuki Yamamoto, Sagamihara (JP); Takashi Watanabe, Odawara (JP); Miyuki Yasuda, Sagamihara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/031,905

(22) Filed: Feb. 15, 2008

(30) Foreign Application Priority Data
Dec. 18, 2007 (JP) 2007-326552

(51) Int. Cl. G06F 17/00

(52) U.S. Cl. 707/202; 707/E17.005

(57) ABSTRACT

A primary storage system and a secondary storage system are connected via a copy network in this computer system. This computer system includes a measurement unit for measuring an update data input amount to be input into the primary update data storage area, a calculation unit for calculating a recovery point in each given period of time based on the measured update data input amount and the band of the copy network, and a comparison unit for comparing the calculated recovery point and a target recovery point to be pre-set as a target value for recovering the update data.

### CROSS REFERENCES

This application relates to and claims priority from Japanese Patent Application No. 2007-326552, filed on Dec. 18, 2007, the entire disclosure of which is incorporated herein by reference.

### BACKGROUND

The present invention generally relates to a computer system configured from a computer and a storage apparatus, and in particular relates to a data loss prevention method for preventing the loss of data stored in a storage apparatus.

Recently, the use of computer systems in which a host computer and a storage apparatus are connected is increasing in companies, and the importance of data stored in such computer systems is also increasing. Data protection is one of the high-priority issues in corporate practice, and the loss of data could even cause significant damage to corporate management.

Conventionally, measures have been taken to protect data by employing various technologies such as duplicating data in the storage apparatus or adopting a RAID (Redundant Array of Inexpensive/independent Disk) configuration. Nevertheless, no matter what kind of measures are taken in the storage apparatus, if a large-scale disaster occurs, it is possible that the storage apparatus itself will be lost. Thus, remote copy technology is employed for protecting data even in cases of undergoing such large-scale disaster, and enabling the resumption of business.

The remote copy technology is technology of installing storage apparatuses at two remote locations, and duplicating data between such storage apparatuses. In other words, when a copy source storage apparatus receives a write request from a host computer, data is stored in the storage apparatus (self storage apparatus) that directly received the write request, and also stored in a copy destination storage apparatus installed at a remote location.

The remote copy technology can be classified into synchronous remote copy and asynchronous remote copy, and can be used creatively depending on the objective of the storage apparatus or the distance between the storage apparatuses. Synchronous remote copy is the method of sending a write completion notice to the host computer that sent the write request after the writing of data into the copy source storage apparatus and the copy destination storage apparatus installed at a remote location is complete. Asynchronous remote copy is the method of sending a write completion notice to the host computer that sent the write request at the point in time the writing of data into the copy source storage apparatus is complete without waiting for the completion of writing of data into the copy destination storage apparatus.

With asynchronous remote copy, when the storage apparatus receives a write request from the host computer, it writes the write data (update data) in a cache or a data storage area of the self storage apparatus, and in a buffer storage area (hereinafter referred to as the “buffer area”) for temporarily storing the update data in order to perform remote copy to the copy destination storage apparatus, and then sends a write completion notice to the host computer. The update data written into the buffer area is sent to the storage apparatus installed at a remote location via a remote copy line asynchronously with the foregoing write completion notice. When the copy source storage apparatus receives an update data transfer completion notice from the copy destination storage apparatus, it deletes the update data from the buffer area.

With asynchronous remote copy, when the accumulation amount of the update data nears the capacity of the buffer area or reaches the same capacity as the buffer area as a result of the update data pending transfer being accumulated in the buffer area, the copy source storage apparatus restricts the reception of write requests from the host computer. In order to avoid this kind of influence on the host computer, there is technology for controlling the band of the remote copy line in accordance with the accumulation amount of the update data pending transfer in the buffer area (Japanese Patent Laid-Open Publication No. 2006-59260; Patent Document 1). In other words, Patent Document 1 discloses technology for controlling the amount of the update data to be transferred by controlling the band of the remote copy line.

In a computer system that adopts measures for protecting data such as with a storage apparatus that employs remote copy, there is an index referred to as a target recovery point (RPO (Recovery Point Objective)). This RPO represents the target value of resuming business using data (state) that is closest to the time that a failure or a disaster occurred in order to fully recover the computer system subject to such failure or disaster. For instance, if the requisite condition of the RPO (hereinafter referred to as the “RPO requirement”) is set as 5 minutes, it is necessary to construct a system that is capable of recovering data at a point in time that is closer than 5 minutes from the time that a failure or disaster occurs even when the data referred to by the host computer is lost due to such failure or disaster.

### SUMMARY

In a computer system employing remote copy, if the computer system is lost due to a disaster, the update data pending transfer accumulated in the buffer area of the copy source storage apparatus will also be completely lost.

In order to avoid this kind of data loss, a computer system is often designed to secure a remote copy line bandwidth that is sufficiently broad according to the peak time of the write load from the host computer so that the data pending transfer is not accumulated in the buffer area of the copy source storage apparatus. Nevertheless, since an expensive dedicated line is often used as the remote copy line, this causes an increase in the remote copy installation cost and operation cost.

Meanwhile, if the remote copy line bandwidth is narrowed to reduce the installation cost and operation cost, update data will be accumulated in the buffer area of the copy source storage apparatus, and the possibility of data loss during a disaster will increase. In other words, depending on the amount of the update data accumulated in the buffer area of the copy source storage apparatus, there is a possibility that the RPO requirement will not be satisfied.

Like this, the line cost and RPO requirement of remote copy are of a reciprocal relationship. Nevertheless, conventionally, it was not possible to properly evaluate the achievement level of the RPO requirement during the designing or operation of the computer system. As a result, it was not possible to decide the smallest possible remote copy line bandwidth in a range that satisfies the RPO requirement during the designing process while giving consideration to both the line cost and RPO requirement of remote copy.

Thus, an object of the present invention is to propose a computer system and a data loss prevention method capable of deciding the smallest possible remote copy line bandwidth in a range that satisfies the RPO requirement.

In order to achieve the foregoing object, the present invention provides a computer system comprising a primary storage system having a primary update data storage area for temporarily storing update data from a host computer, a secondary storage system for asynchronously storing copy data of the update data in a secondary update data storage area pair-configured with the primary update data storage area, and a management computer for managing the primary storage system or the secondary storage system. The primary storage system and the secondary storage system are connected via a copy network, and the primary storage system and the secondary storage system and the management computer are connected via a management network. The computer system further comprises a measurement unit for measuring an update data input amount to be input into the primary update data storage area, a calculation unit for calculating a recovery point in each given period of time based on the measured update data input amount and the band of the copy network, and a comparison unit for comparing the calculated recovery point and a target recovery point to be pre-set as a target value for recovering the update data.

Thereby, it is possible to determine the constituent features concerning remote copy while satisfying the requirements of a recovery point.

The present invention further provides a computer system comprising a primary storage system having a primary update data storage area for temporarily storing update data from a host computer, a secondary storage system for asynchronously storing copy data of the update data in a secondary update data storage area pair-configured with the primary update data storage area, and a management computer for managing the primary storage system or the secondary storage system. The primary storage system and the secondary storage system are connected via a copy network, and the primary storage system and the secondary storage system and the management computer are connected via a management network. The computer system further comprises a recovery point calculation unit for calculating, as a recovery point of the update data at an arbitrary time, a coinciding time in which an update data accumulation amount of the update data accumulated in the primary update data storage area at the arbitrary time coincides with the total amount of update data input into the primary update data storage area; and a recovery point comparison unit for comparing a recovery point calculated in a time-series at designated time intervals with the recovery point calculation unit and a target recovery point pre-set with a target point for recovering the update data.

Thereby, it is possible to set the network line bandwidth for connecting the primary storage system and the secondary storage system to an optimal band while satisfying a target recovery point.

The present invention additionally provides a data loss prevention method of a computer system comprising a primary storage system having a primary update data storage area for temporarily storing update data from a host computer, a secondary storage system for asynchronously storing copy data of the update data in a secondary update data storage area pair-configured with the primary update data storage area, and a management computer for managing the primary storage system or the secondary storage system. The primary storage system and the secondary storage system are connected via a copy network, and the primary storage system and the secondary storage system and the management computer are connected via a management network. The data loss prevention method comprises a measurement step for measuring an update data input amount to be input into the primary update data storage area, a calculation step for calculating a recovery point in each given period of time based on the measured update data input amount and the band of the copy network, and a comparison step for comparing the calculated recovery point and a target recovery point to be pre-set as a target value for recovering the update data.

Thereby, it is possible to determine the constituent features concerning remote copy while satisfying the requirements of a recovery point.

The present invention additionally provides a data loss prevention method of a computer system in which a primary storage system having a primary update data storage area for temporarily storing update data from a host computer, a secondary storage system for asynchronously storing copy data of the update data in a secondary update data storage area pair-configured with the primary update data storage area, and a management computer for managing the primary storage system or the secondary storage system are connected via a network. The data loss prevention method comprises a recovery point calculation step for calculating, a coinciding time in which an update data accumulation amount of the update data accumulated in the primary update data storage area at the arbitrary time coincides with the total amount of update data input into the primary update data storage area; and a recovery point comparison step for comparing a recovery point calculated in a time-series at designated time intervals with the recovery point calculation unit and a target recovery point pre-set with a target point for recovering the update data.

Thereby, it is possible to set the network line bandwidth for connecting the primary storage system and the secondary storage system to an optimal band while satisfying a target recovery point.

The present invention calculates the update data accumulation amount of a data update storage area as a buffer area and a feasible recovery point based on the result of monitoring the amount of data written from the host computer into the storage system. In this invention, a recovery point means the latest point in time that the data can be restored in a storage system of a remote location when one of the storage systems is subject to a disaster and business operation is to be resumed upon moving the business base to a storage system in a remote location.

In addition, the present invention is able to determine the constituent features of remote copy such as the line bandwidth of remote copy while satisfying the RPO requirement based on the calculated update data accumulation amount and recovery point.

According to the present invention, it is possible to decide the smallest possible remote copy line bandwidth in a range that satisfies the RPO requirement.

### DESCRIPTION OF DRAWINGS

FIG. 1 is a block diagram showing an example of the connection mode of a computer system according to the first embodiment;

FIG. 2 is a block diagram showing an example of the internal configuration of a storage apparatus according to the first embodiment;

FIG. 3 is a chart showing a pair configuration management table according to the first embodiment;

FIG. 4 is a chart showing a performance information management table of an update data storage area according to the first embodiment;

FIG. 5 is a chart showing a performance information management table of a copy interface according to the first embodiment;

FIG. 6 is a block diagram showing an example of the internal configuration of a management computer according to the first embodiment;

FIG. 7 is a chart showing a monitoring information management table according to the first embodiment;

FIG. 8 is a chart showing a line bandwidth calculation condition management table according to the first embodiment;

FIG. 9 is a chart showing a capacity calculation condition management table according to the first embodiment;

FIG. 10 is a chart showing an RPO requirement management table according to the first embodiment;

FIG. 11 is a screen diagram showing an input screen of monitoring information according to the first embodiment;

FIG. 12 is a screen diagram showing an input screen of a line bandwidth calculation condition according to the first embodiment;

FIG. 13 is a screen diagram showing an input screen of a capacity calculation condition according to the first embodiment;

FIG. 14 is a screen diagram showing an input screen of an RPO requirement according to the first embodiment;

FIG. 15 is a flowchart showing the operation processing according to the first embodiment;

FIG. 16 is a screen diagram showing a management screen after executing the operation processing according to the first embodiment;

FIG. 17 is a flowchart showing calculation processing according to the first embodiment;

FIG. 18 is a flowchart showing calculation processing according to the first embodiment;

FIG. 19 is a graph showing the calculation result of an update data accumulation amount according to the first embodiment;

FIG. 20 is a graph showing the calculation result of a recovery point value according to the first embodiment;

FIG. 21 is a block diagram showing the internal configuration of a management computer according to the second embodiment;

FIG. 22 is a chart showing a threshold value management table according to the second embodiment;

FIG. 23 is a chart showing a recovery point monitoring log according to the second embodiment;

FIG. 24 is a chart showing a monitoring timing table according to the second embodiment;

FIG. 25 is a flowchart showing monitoring operation processing according to the second embodiment; and

FIG. 26 is a flowchart showing monitoring processing according to the second embodiment.

### DETAILED DESCRIPTION

### (1) First Embodiment

(1-1) Configuration of Computer System

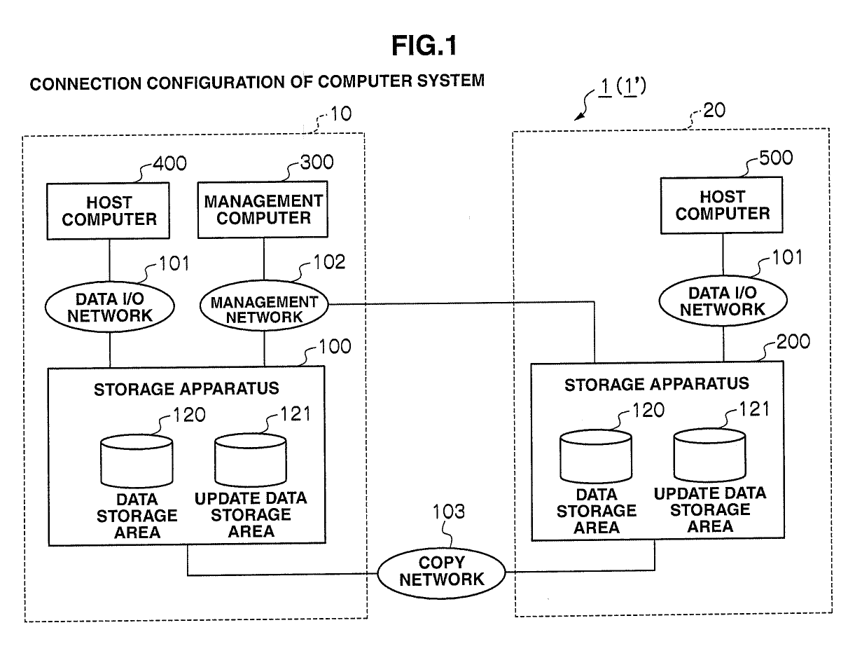

The first embodiment of the present invention is now explained with reference to FIG. 1 to FIG. 20.

FIG. 1 shows a computer system 1 according to the first embodiment. The objective of the computer system 1 in the first embodiment is to conduct the evaluation and determination upon introducing remote copy technology to an existing computer system.

The computer system 1 is configured by a host computer 400 and a storage apparatus 100, and a computer 500 and a storage apparatus 200 respectively being connected via a data I/O network 101, the storage apparatus 100 and the storage apparatus 200 being connected via a copy network 103, and the management computer 300 being connected to the storage apparatus 100 and the storage apparatus 200 via a management network 102.

The data I/O network 101 and the copy network 103 are configured from a standard network connection topology such as a fibre channel, an IP network or the like.

The management network 102 is configured from a standard network connection topology such as an IP network. The management network 102 may also be shared as the same network as the foregoing data I/O network 101 or the copy network 103.

The storage apparatus 100 is a primary storage system, and is a copy source storage apparatus. The storage apparatus 100 includes a data storage area (primary data storage area) 120 for directly storing the received data upon receiving a write request from the host computer 400. The storage apparatus 100 also includes an update data storage area (primary update data storage area) 121 for temporarily storing the update data created with the data copy program 132 described later.

The storage apparatus 200 is a secondary storage system, and a copy destination storage apparatus. The storage apparatus 200 includes an update data storage area (secondary update data storage area) 121 for temporarily storing the update data transferred from the storage apparatus 100, and a data storage area (secondary data storage area) 120 for storing the update data transferred from the storage apparatus 100. The data storage area 120 directly stores the received data upon receiving a write request from the host computer 500. The remaining configuration of the storage apparatus 200 is the same as the configuration of the foregoing storage apparatus 100, and the detailed explanation thereof is omitted.

In this embodiment, the area enclosed with the dotted line 10 shows the primary storage system 10, and the area enclosed with the dotted line 20 shows the secondary storage system 20.

In addition, although the management computer 300 is included in the primary storage system 10, it may also be included in the secondary storage system 20, and there is no limitation on the connection topology of the management computer 300.

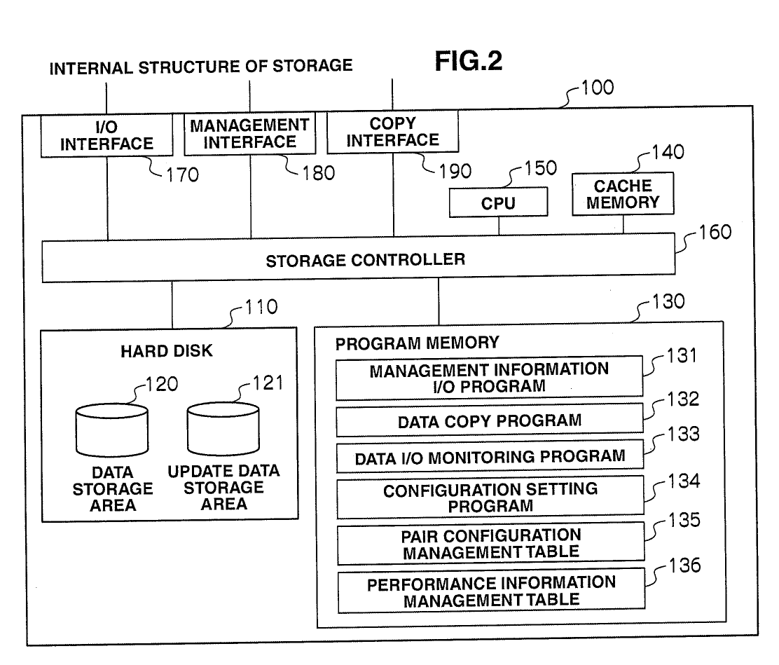

The internal configuration of the storage apparatus 100 is now explained with reference to FIG. 2. FIG. 2 is a view showing a frame format of the internal structure of the storage apparatus 100 that is the same as the storage apparatus 100 illustrated in FIG. 1.

The storage apparatus 100 internally comprises a storage controller 160, and a hard disk 110, a program memory 130, a cache memory 140, and a CPU 150 are respectively connected to the storage controller 160. The storage apparatus 100 communicates with external apparatuses via an I/O communication interface 170, a management interface 180, and a copy interface 190 connected to the storage controller 160 according to the application thereof. Specifically, the I/O communication interface 170 is used for communicating with the host computer 400, the management interface 180 is used for communicating with the management computer 300, and the copy interface 190 is used for communicating with the storage apparatus 200.

The cache memory 140 would suffice so as long as it is physically a standard semiconductor storage apparatus, and is used as a temporary data storage area as in a general purpose computer.

The hard disk 110 is configured, for example, from one or more magnetic disk devices; that is, devices which are generally known as hard disks, and can be used by being logically partitioned into a plurality of data storage areas. The hard disk 110 configures the data storage area 120 for storing data to be read from or written into the host computer 400. The hard disk 110 also configures the update data storage area 121 for temporarily storing the update data to be stored in the data storage area 120. Incidentally, there is no particular limitation on the capacity or quantity of the data storage area 120 and the update data storage area 121 in this specification.

As used herein, the term “update data” includes the write data (updated data) written into the storage area 120 and the management information pertaining to such write data. Management information pertaining to write data is, for example, management information such as the update time (when the data was written), the update order number, and the update position (in which position of which data storage area the data was written).

The program memory 130 is physically a storage area configured from a magnetic disk device or a semiconductor storage apparatus. The program memory 130 retains various program groups and various types of information that undertake operations of the storage apparatus 100, and the storage controller 160 or the CPU 150 executes the various programs 131 to 134 described later by reading such various program groups and various types of information. The program memory 130 stores a management information I/O program 131, a data copy program 132, a data I/O monitoring program 133, a configuration setting program 134, a pair configuration management table 135, and a performance information management table 136.

If a computer program is referred to as the subject in the ensuing explanation, in reality, let it be assumed that the processing is performed by the CPU that executes such computer program.

The programs and tables stored in the program memory 130 are explained below.

The management information I/O program 131 is a program for transferring management information between the storage apparatus 100 and the management computer 300. The management information I/O program 131 also transmits the received management information to a program or a table in the program memory 130. For example, if a monitoring data acquisition request is sent from the management computer 300 to the storage apparatus 100, the management information I/O program 131 receives the monitoring data acquisition request and then sends it to the data I/O monitoring program 133.

The data copy program 132 creates update data upon receiving a data write request for writing data into the data storage area 120. Update data is copy data of the write data that is created for being sent to the storage apparatus 200. Management information is assigned to the update data. Then, the update data is stored in the update data storage area 121 asynchronously with the write processing of storing the write data into the data storage area 120. This update data is also transferred to the storage apparatus 200 having the data storage area 120 that is defined as a pair (combination to form a pair) in the pair configuration management table 135 described later.

In this regard, however, the data copy program 132 may temporarily store the update data in the cache memory 140, and the data copy program 132 may read such update data from the cache memory and transfer it to the storage apparatus 200 via the copy interface 190.

When the data copy program 132 receives a data transfer completion notice from the storage apparatus 200, it deletes the foregoing update data from the update data storage area 121.

In addition, the update data storage area 121 itself may be an area in the cache memory 140, and not a storage area in the hard disk 110. In this case, the data copy program 132 will store the update data in the cache memory 140, and transfer the update data to the storage apparatus 200 having the data storage area 120 defined as a pair (combination to form a pair) in the pair configuration management table 135 described later asynchronously with the data write processing for writing data into the data storage area 120.

The data I/O monitoring program 133 acquires management information concerning the I/O request from the host computer 400 in relation to the data storage area 120 to be monitored in each data acquisition time interval (point interval). The data acquisition time interval is the monitoring period indicated in the monitoring data acquisition request received from the management computer 300.

The management information includes at least the write data amount from the host computer 400 acquired at the data acquisition time interval indicated in the monitoring data acquisition request.

If the operation of data copy has already been started by the foregoing data copy program 132, the data I/O monitoring program 133 acquires management information concerning the data amount accumulated in the update data storage area 121 or the utilization in the storage area.

The acquired data may be the average value or the total value of data acquired in data acquisition time intervals. Aside from this, the maximum value or the minimum value may be acquired.

The configuration setting program 134 sets the configuration in the storage apparatus 100 based on the contents described in the configuration setting request upon receiving such configuration setting request from the management computer 300 via the management information I/O program 131. Specifically, the configuration setting program 134 sets the configuration of the copy interface 190 and the update data storage area 121.

The setting of the update data storage area 121 is performed by referring to the performance information table 136A of the copy interface 190 described later. For example, if the performance of the update data storage area 121 in current use is 30 MB/s, and the request performance of the update data storage area 121 is indicated as 60 MB/s in the configuration setting request, the configuration setting program 134 detects an unused update data storage area 121 from the performance information table 136A described later. The configuration setting program 134 additionally sets the update data storage area 121 to be used by registering the corresponding pair identifier in the field 1362a. Here, the performance of the update data storage area 121 refers to the communication speed of data to be input to and output from the update data storage area 121.

The setting of the copy interface 190 is performed by referring to the performance information table 136B of the copy interface 190 described later. For example, if the performance of the copy interface 190 in current use is 100 MB/s, and the request performance of the copy interface 190 is indicated as 200 MB/s in the configuration setting request, the configuration setting program 134 additionally sets the copy interface 190 to be used by detecting an unused copy interface from the performance information table 136B described later, and updating the usage status (field 1362b) from “unused” to “used.” Here, the performance of the copy interface refers to the communication speed of data to be input and output using the copy interface.

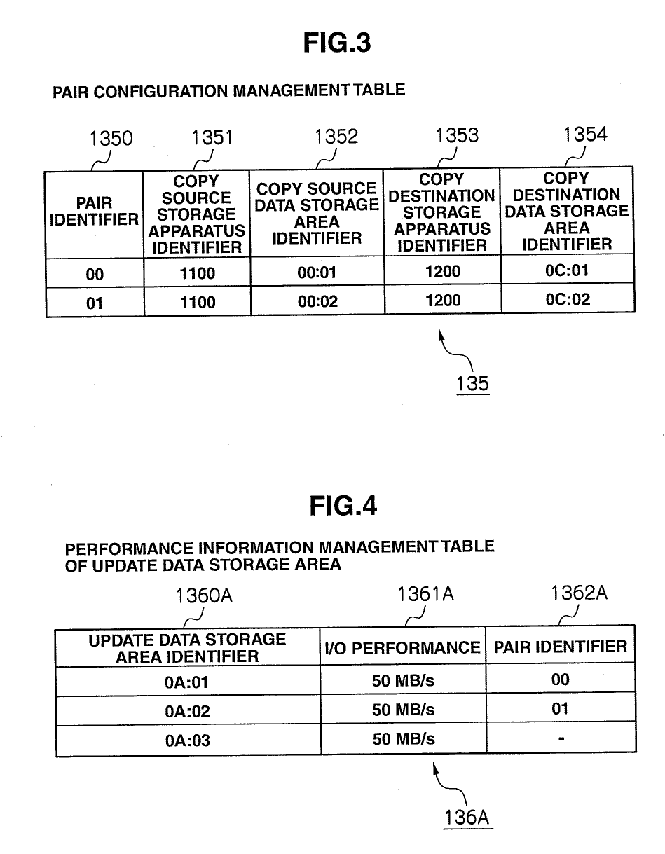

The pair configuration management table 135 stores information concerning the data copy of the data storage area 120. In data copy, the copy source data storage area 120 and the copy destination data storage area 120 configure a pair relationship. An example of the pair configuration management table 135 is shown in FIG. 3.

The pair configuration management table 135 includes a field 1350 for storing a pair identifier, a field 1351 for storing an identifier of the storage apparatus 100 retaining the copy source data, a field 1352 for storing an identifier of the copy source data storage area 120, a field 1353 for storing an identifier of the storage apparatus to become the copy destination, and a field 1354 for storing an identifier of the copy destination data storage area 120.

For example, in FIG. 3, the pair represented with the pair identifier 00 shows a pair configuration where the data storage area identified with the identifier 00:01 in the storage apparatus 1100 is the copy source, and the data storage area identified with the identifier 0C:01 in the storage apparatus 1200 is the copy destination.

The performance information management table 136 stores information concerning the performance in the storage apparatus 100. The performance information management table 136 includes at least a performance information management table 136A of the update data storage area, and a performance information management table 136B of the copy interface.

The performance information management table 136A of the update data storage area manages information concerning the I/O performance of the storage area used as the update data storage area 121 in the storage apparatus 100. An example of the performance information management table of the update data storage area 121 is shown in FIG. 4. The performance information management table 136A of the update data storage area 121 includes a field 1360A for recording an identifier of the storage area used as the update data storage area 121, a field 1361A for recording the I/O performance for each update data storage area, and a field 1362A for recording an identifier of a pair to which the update data stored in the update data storage area belongs. There is no need to restrict the conditions such as the write data length to become the prerequisite for the I/O performance.

For example, FIG. 4 shows that the I/O performance of the update data storage area 121 identified with the identifier 0A:01 is 50 MB/s, and such update data storage area 121 is being used as the update data storage area of the pair identified with the pair identifier 00. Further, FIG. 4 shows that the I/O performance of the update data storage area 121 identified with the identifier 0A:03 is 50 MB/s, and “-” showing that a pair identifier has not been allocated is recorded in the field 1362a.

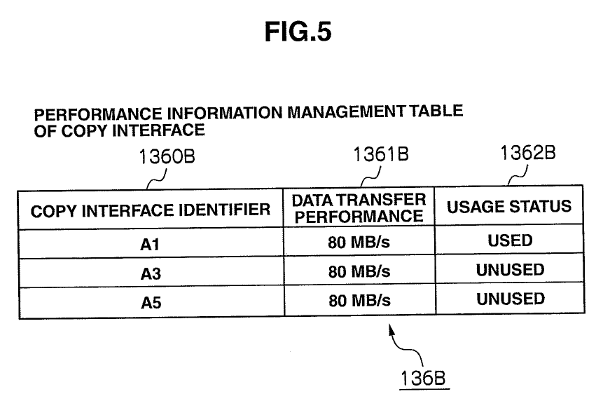

The performance information management table 136B of the copy interface manages information concerning the I/O performance of the copy interface 190 in the storage apparatus 100. An example of the performance information management table of the copy interface is shown in FIG. 5. The performance information management table 136B of the copy interface 190 includes a field 1360B for recording an identifier of the copy interface 190, a field 1361B for recording the data transfer performance for each copy interface 190, and a field 1362B for recording the usage status of that copy interface 190.

For example, FIG. 5 shows that the data transfer performance of the copy interface 190 identified with the identifier A1 is 80 MB/s, and the copy interface 190 is currently being used.

In this embodiment, the copy interface 190 to be used for the data copy shall be shared among a plurality of copy pairs, and the setting for associating the copy interface 190 to each pair is not performed. Thus, when “used” is indicated in the field 1362B of FIG. 5 regarding the copy interface performance of the storage system 10, this indication may be deemed to be the result of all data transfer performances being added.

The scope of the present invention, however, is not limited to this embodiment, and covers cases of setting the copy interface 190 for each pair.

The internal configuration of the storage apparatus 200 is the same as the storage apparatus 100, and the detailed explanation thereof is omitted.

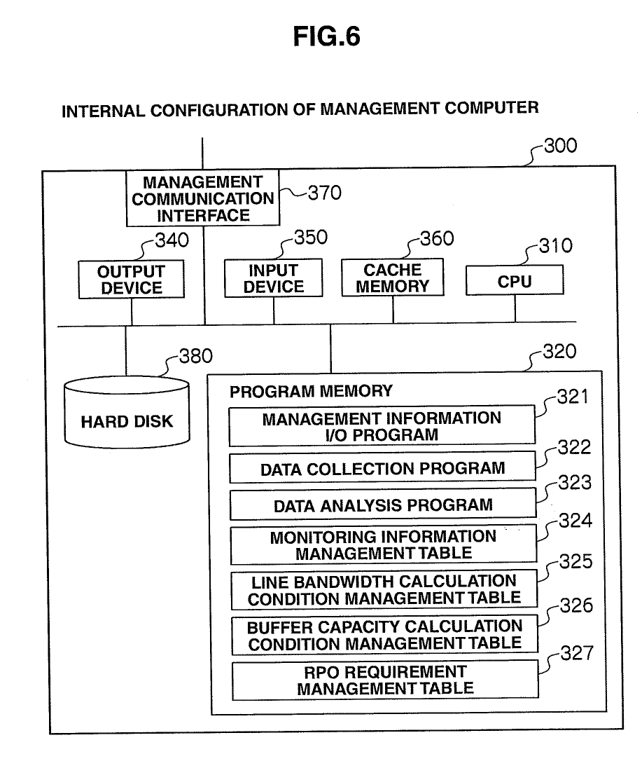

The internal configuration of the management computer 300 is now explained with reference to FIG. 6. FIG. 6 is a view showing a frame format of the internal structure of the management computer 300 that is the same as the management computer 300 illustrated in FIG. 1.

The management computer 300 comprises a CPU 310, a program memory 320, a hard disk 330, an output device 340, an input device 350, a cache memory 360, and a management interface 370, and the respective components are connected via a bus. The hardware configuration of the management computer 300, for instance, may be the same as a general-purpose computer (PC). For example, the input device 350 may be a device such as a keyboard or a mouse, and the output device 340 may be a display device or a video output device such as a CRT (Cathode Ray Tube) or an LCD (Liquid Crystal Display). Similarly, the management interface 370 may be a general-purpose communication device such as the Ethernet (registered trademark).

The program memory 320 may be a data storage device configured from a magnetic storage apparatus or a semiconductor storage apparatus. The program memory 320 stores at least a management information I/O program 321, a data collection program 322, a data analysis program 323, a monitoring information management table 324, a line bandwidth calculation condition management table 325, a capacity calculation condition management table 326, and an RPO requirement management table 327. The programs 321 to 323 stored in the program memory 320 are read and executed by the CPU 350. The CPU 350 refers to the necessary tables stored in the program memory 320 upon executing the various programs.

The programs 321 to 323 and tables 324 to 327 stored in the program memory 320 of the management computer 300 are explained below.

The management information I/O program 321 transfers management information between the management computer 300 and the storage apparatus 100. The management information I/O program 321 also sends the management information received from the storage apparatus 100 to a program or a table in the program memory 320. In other words, the CPU 350 executes the management information I/O program 321 and stores the received management information in the program memory 320, and uses the management information to execute a separate program.

The data collection program 322 collects management information concerning the storage apparatus 100 via the management information I/O program 321. Specifically, upon receiving a remote copy configuration evaluation request from the user, the data collection program 322 issues a monitoring data acquisition request to the storage apparatus 100, and acquires information concerning the monitoring data acquired by the data I/O monitoring program 133 of the storage apparatus 100 according to the foregoing request.

The monitoring data acquisition request indicates information such as the identifier, monitoring period, data acquisition interval and so on of the monitoring target storage area recorded in the monitoring information management table 325 described later.

The data analysis program 323 uses the monitoring data collected with the data collection program 322 to calculate the estimated data amount to be accumulated in the update data storage area 121 during the monitoring period. Details concerning the processing flow of the data analysis program 323 will be described later.

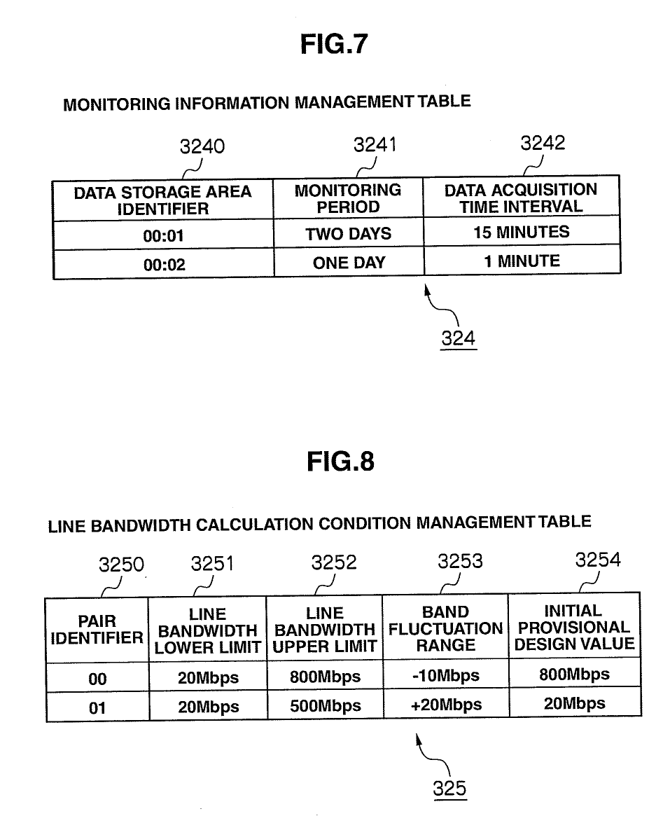

The monitoring information management table 324 accumulates management information indicated in the monitoring data acquisition request to be sent to the storage apparatus 100 via the management information I/O program 321. An example of the monitoring information management table 324 is shown in FIG. 7. Specifically, the monitoring information management table 324 accumulates at least a field 3240 showing an identifier of the data storage area 120 to be monitored, a field 3241 showing the monitoring period of the monitoring target, and a monitoring data acquisition time interval field 3242.

For instance, in the example of FIG. 7, the monitoring period of the data storage area 120 identified with the identifier “00:01” is 2 days, and the data acquisition time interval is 15 minutes. These parameters may be defined by the user in advance. The monitoring information may also be decided based on factors such as the type of data or application, or the degree of importance.

The line bandwidth calculation condition management table 325 stores information concerning the line bandwidth evaluation to be used in the data analysis program 323. An example of the line bandwidth calculation condition management table 325 is shown in FIG. 8. The line bandwidth calculation condition management table 325 includes a field 3250 for storing a pair identifier showing the unit of calculating and evaluating the line bandwidth, a field 3251 for storing the lower limit of the line bandwidth, a field 3252 for storing the upper limit of the line bandwidth, a field 3253 for storing the band fluctuation range to be used in the simulation of the data analysis program 323, and a field 3254 for setting the initial provisional design value in the data analysis program 323.

For example, in FIG. 8, the unit of evaluating the line bandwidth is the range of the storage area defined with the pair identifier, and this pair identifier may be based on the pair configuration management table 134 retained in the storage apparatus 100. Here, when evaluating the line bandwidth to the storage area identified with the pair identifier 00, the lower limit thereof is 20 Mbps, and the upper limit is 800 Mbps. The simulated band fluctuation range is −10 Mbps, and the initial setting is the upper limit setting. Thereby, the line bandwidth to the storage area identified with the pair identifier 00 is set to 800 Mbps in the initial setting, and set so that the band fluctuation is reduced 10 Mbps at a time from the initialization value each time simulation is executed.

Meanwhile, the line bandwidth to the storage area identified with the pair identifier 01 is set to 20 Mbps in the initial setting, and set so that the band fluctuation is increased 20 Mbps at a time from the initialization value each time simulation is executed.

These values may also be decided based on factors such as the degree of importance of the application that refers to the storage area to be subject to data copy, or the characteristics of the data.

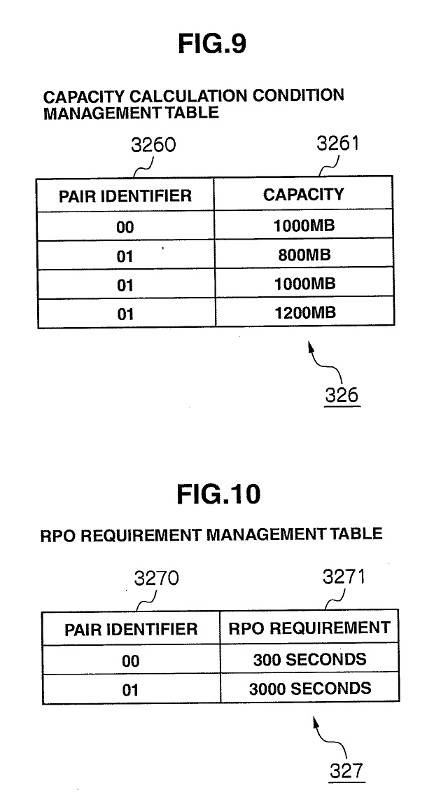

The capacity calculation condition management table 326 stores information concerning the capacity of the update data storage area 121 to be used in the data analysis program 323. An example of the capacity calculation condition management table 326 is shown in FIG. 9. The capacity calculation condition management table 326 includes a field 3260 for storing a pair identifier showing the unit of calculating and evaluating the capacity of the update data storage area 121, and a field 3261 for registering the candidate value of the capacity.

The example of FIG. 9 shows that 1000 MB is registered as the capacity of the update data storage area 121 with regard to the pair identified with the identifier “00.”

The RPO requirement management table 327 manages information concerning the RPO of each storage area to be subject to data copy. An example of the RPO requirement management table 327 is shown in FIG. 10. The RPO requirement management table 327 includes at least a field 2370 for storing a pair identifier, and a field 2371 for storing the RPO requirement. In FIG. 10, since the RPO requirement is set to 300 seconds, this shows that data up to 300 seconds ago can be recovered even when the data referred to by the host computer 400 is lost in the storage area identified with the pair identifier 00 due to a failure or a disaster.

The various tables 324 to 327 described above are set by the user using the management screen of the management computer 300. The situation of the user setting the management screen of the management computer 300 is explained below.

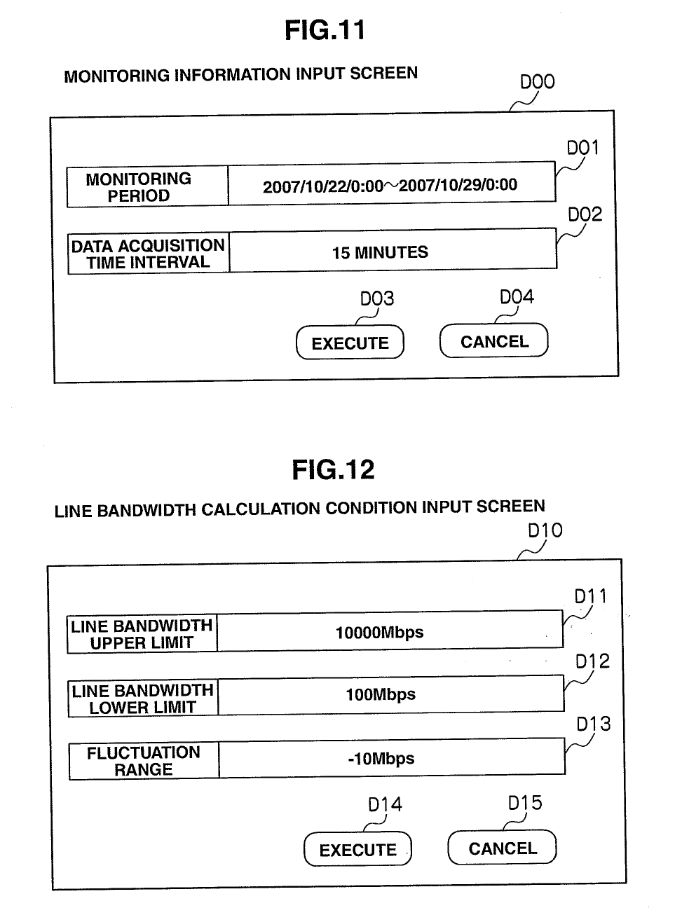

Foremost, an example of the monitoring information input screen to be used by the user for inputting monitoring information is shown in FIG. 11. The monitoring information input screen DOO includes a field D01 to which the monitoring period is input, a field D02 to which the data acquisition interval is input, and so on. The monitoring information input screen DOO also has an execution button D03 to be pressed by the user for registering the input monitoring period and data acquisition interval, and a cancel button D04 to be pressed by the user for cancelling the input monitoring period and data acquisition interval. Triggered by the pressing of the execution button D03, the data collection program 322 registers the input monitoring period and data acquisition interval in the monitoring information management table 324. Incidentally, the monitoring information input screen DOO illustrated in FIG. 11 is merely an example, and there is no particular limitation on the configuration or type of information to be displayed.

An example of the line bandwidth calculation condition input screen for the user to input the line bandwidth calculation conditions is shown in FIG. 12. The line bandwidth calculation condition input screen D10 includes a field D11 to which the line bandwidth upper limit is input, a field D12 to which the line bandwidth lower limit is input, a field D13 to which the line bandwidth fluctuation range is input, and so on. The line bandwidth calculation condition input screen D10 also has an execution button field D11 to be pressed by the user for registering the input line bandwidth upper limit, line bandwidth lower limit and fluctuation range, and a cancel button D15 to be pressed by the user for cancelling the input line bandwidth upper limit, line bandwidth lower limit and fluctuation range. Triggered by the execution button D14 being pressed, the data analysis program 323 registers the input line bandwidth upper limit, line bandwidth lower limit and fluctuation range in the line bandwidth calculation condition management table 325. Incidentally, the line bandwidth calculation condition input screen illustrated in FIG. 12 is merely an example, and there is no particular limitation on the configuration or type of information to be displayed.

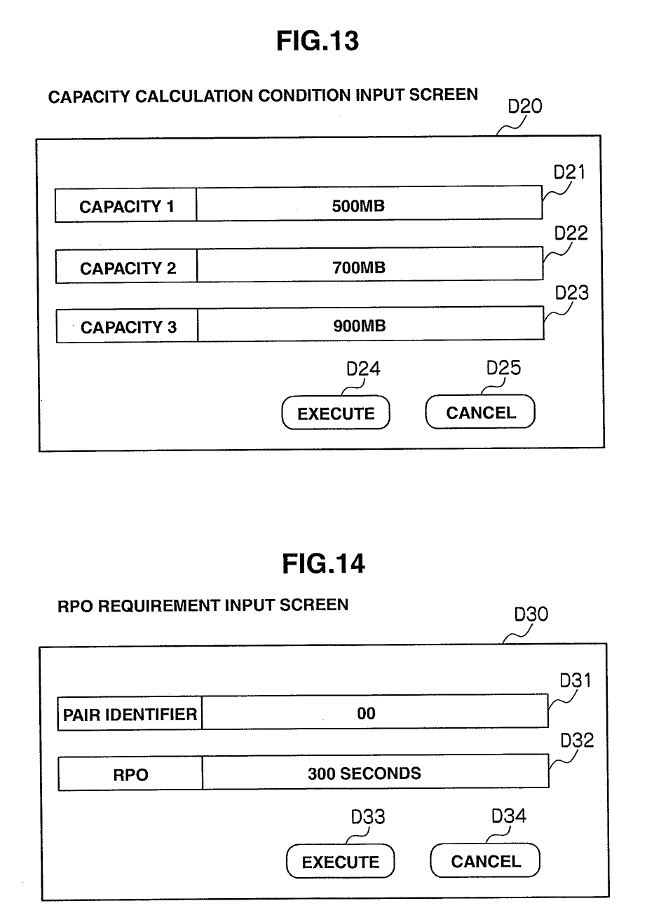

An example of the capacity calculation condition input screen for the user to input the capacity calculation conditions is shown in FIG. 13. The capacity calculation condition input screen D20 includes fields D21, D22 and D23 to which a plurality of capacities are input, an execution button D24 to be pressed by the user for registering the input capacity, and a cancel button D25 to be pressed by the user for registering the input capacity. Triggered by the pressing of the execution button D24, the data analysis program 323 registers the input capacity in the capacity calculation condition management table 326. Incidentally, the capacity calculation condition input screen illustrated in FIG. 13 is merely an example, and there is no particular limitation on the configuration or type of information to be displayed.

An example of the RPO requirement input screen for the user to input the RPO requirement is shown in FIG. 14. The RPO requirement input screen D30 includes a field D31 to which a pair identifier is input, a field D32 to which the RPO requirement is input, and so on. The RPO requirement input screen also has an execution button D33 to be pressed by the user for registering the RPO requirement in relation to the input pair identifier, and a cancel button D34 to be pressed by the user for cancelling the input RPO requirement. Triggered by the pressing of the execution button D33, the data analysis program 323 registers the input RPO requirement in the RPO requirement management table 327. Incidentally, the RPO requirement input screen illustrated in FIG. 14 is merely an example, and there is no particular limitation on the configuration or type of information to be displayed.

(1-2) Data Loss Prevention Processing

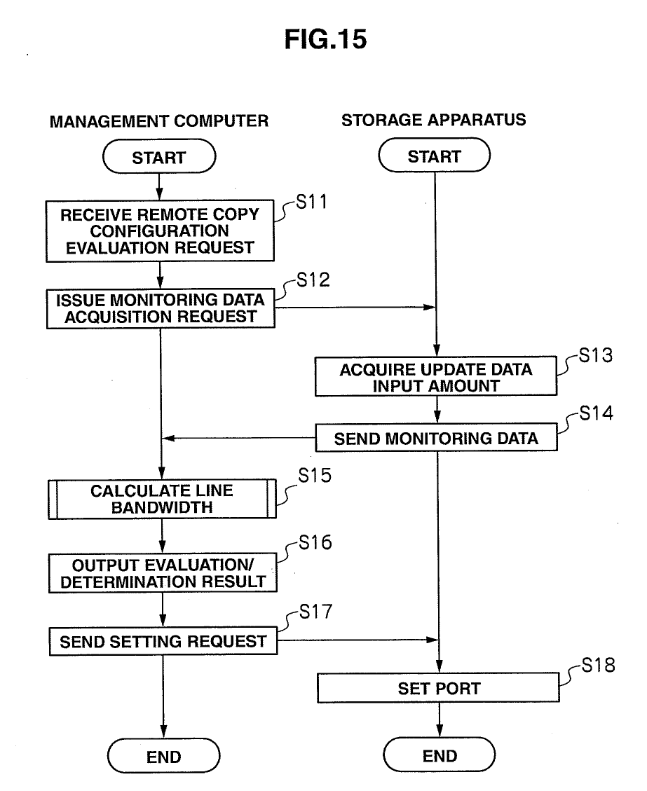

As a result of operating the computer system 1 described above, it is possible to decide the smallest possible line bandwidth while satisfying the RPO requirement. The data loss prevention method of this embodiment is now explained with reference to FIG. 15.

FIG. 15 shows the flow of the sequential data loss prevention processing of this embodiment. Foremost, the management computer 300 receives a remote copy configuration evaluation request based on input operations by the user (administrator) (step S11). The remote copy configuration evaluation request is a request for confirming the evaluation of whether the RPO requirement is being satisfied in the configuration of remote copy.

Subsequently, the CPU 310 executes the data collection program 322, and issues a monitoring data acquisition request to the storage apparatus 100 (step S12). The monitoring data acquisition request is a request for acquiring the input amount of the update data and the pair configuration information concerning the update data stored in the storage apparatus 100. The monitoring data acquisition request indicates at least the identifier and monitoring period of the monitoring target storage area, as well as the time interval for acquiring the data to be monitored designated in the monitoring information management table 324.

When the storage controller 160 of the storage apparatus 100 receives the monitoring data acquisition request, it executes the management information I/O program 131, and sends the monitoring data acquisition request to the data I/O monitoring program 133. The data I/O monitoring program 133 acquires the update data input amount (write data amount) stored in the monitoring target storage area during the monitoring period indicated in the monitoring data acquisition request (step S13).

Subsequently, the storage apparatus 100 sends, as monitoring data, the foregoing update data input amount (write data amount) and information concerning the pair configuration accumulated in the pair configuration management table 135 to the management computer 300 (step S14).

When the management computer 300 receives the monitoring data, the data analysis program 323 uses this monitoring data to simulate the line bandwidth and the capacity of the update data storage area 121 (step S15). Details concerning the performance of simulation will be described later.

When the line bandwidth and the capacity of the update data storage area 121 are decided, the management computer 300 outputs the result to a management screen or the like via the output device (step S16). The line bandwidth determined value calculated in the foregoing simulation, a time-series graph of the update data accumulation amount, and a time-series graph of the recovery point may be output to the management screen. Aside from outputting the final update data accumulation amount or the final calculation result of the recovery point, the update data and the calculation result of the recovery point employing values that are immediately before and after the ultimately decided line bandwidth may also be output.

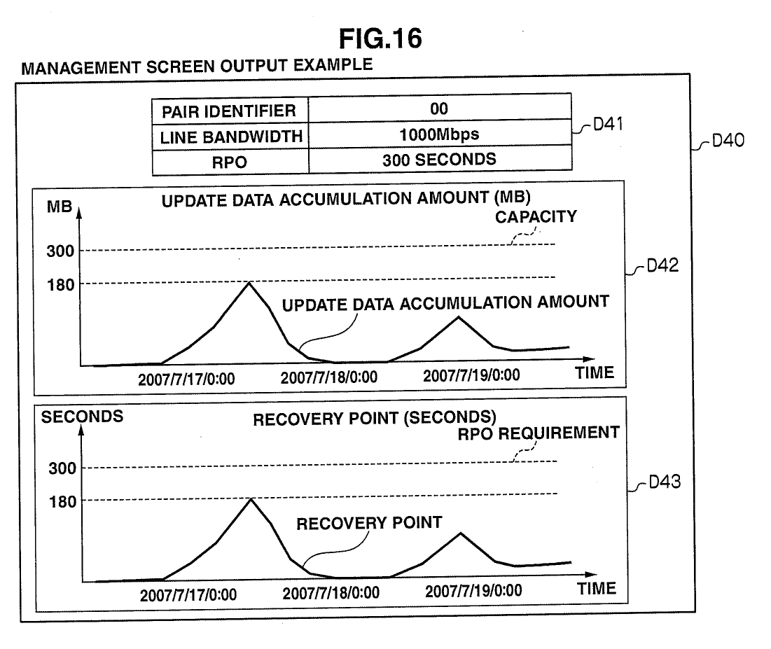

A specific example of the management screen to be output at step S16 is shown in FIG. 16.

In FIG. 16, the management screen D40 includes a field D41 for displaying the line bandwidth decided based on the simulation as well as a pair identifier and the RPO requirement, a field D42 for displaying the transition of the update data accumulation amount calculated with the data analysis program 323, and a field D43 for displaying the transition of the recovery point calculated with the data analysis program 323.

Nevertheless, the data to be output to the management screen is not limited to the above, and may also be output upon being combined with other data such as the transition of the write data amount or the update data transfer amount.

Subsequently, the management computer sends configuration setting request concerning the storage apparatus to the storage apparatus 100 based on the foregoing determination result (step S17). The configuration setting request is a request for setting the I/O data communication speed required in configuring the storage apparatus 100. The configuration setting request includes at least a request performance of the copy interface 190, and a request performance of the update data storage area 121. The request performance value of the copy interface 190 and the request performance value of the update data storage area 121, for instance, may be obtained by converting the line bandwidth determined value calculated with the foregoing data analysis program 323 into units from Mbps to MB/s.

The storage apparatus 100 executes the configuration setting program 134 when it receives the configuration setting request, and sets the performance of the copy interface 190 and the update data storage area 121 based on the performance information indicated in the configuration setting request (step S18).

(1-3) Calculation Processing

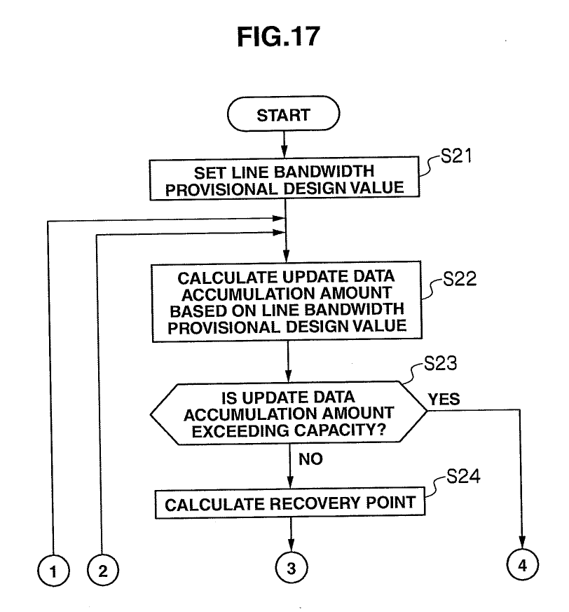

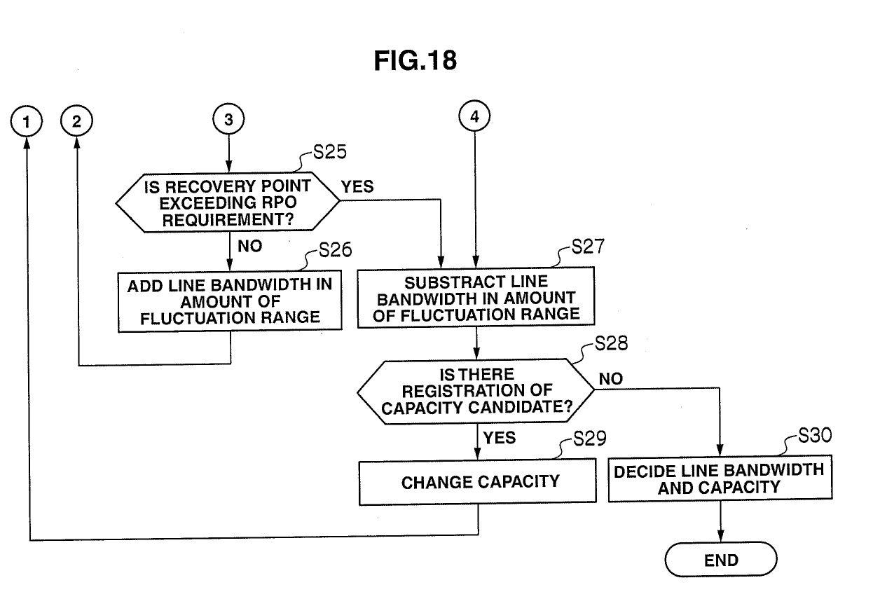

The calculation processing to be executed by the management computer 300 based on the data analysis program 323 for implementing the simulation at step S15 is now explained with reference to FIG. 17 and FIG. 18.

In FIG. 17 and FIG. 18, foremost, the management computer 300 refers to the line bandwidth calculation condition management table 325, and decides the line bandwidth provisional design value (step S21). The line bandwidth provisional design value to be set initially will be the “line bandwidth upper limit” if the value of the band fluctuation range is negative and the “line bandwidth lower limit” if the value of the band fluctuation range is positive in the line bandwidth calculation condition management table 325. For example, in FIG. 8, since the value of the band fluctuation range is positive in the pair identifier 00, the line bandwidth upper limit of 800 Mbps is set as the initial line bandwidth provisional design value.

Subsequently, the management computer 300 calculates the amount of update data to be accumulated at each data acquisition time (hereinafter referred to as the “update data accumulation amount”) in the update data storage area 121 of the storage apparatus 100 based on the line bandwidth provisional design value (step S22). The calculation method of the update data accumulation amount will be described later.

Subsequently, the management computer 300 compares the capacity of the update data storage area 121 acquired by referring to the capacity calculation condition management table 326, and the update data accumulation amount (step S23), and, if the update data accumulation amount is not exceeding the capacity of the update data storage area 121 (step S23; No), calculates the recovery point of the computer system 1 based on the update data accumulation amount (step S24). The calculation method of the recovery point will be described later.

The management computer 300 compares the value of the RPO requirement acquired from the RPO requirement management table 327, and the recovery point (step S25), and, if the recovery point is not exceeding the RPO requirement (step S25; No), adds the line bandwidth in the amount of the band fluctuation range designated in the line bandwidth calculation condition management table 325 from the line bandwidth provisional design value (step S26), and executes the processing at steps S22 onward once again based on the newly obtained line bandwidth provisional design value.

For example, if the line bandwidth upper limit of 800 Mbps is set as the initial line bandwidth provisional design value in the pair identifier 00, the value of 790 Mbps obtained by adding −10 Mbps to the band fluctuation range will become the new line bandwidth provisional setting value.

If the update data accumulation amount is exceeding the capacity of the update data storage area 121 at step S23 (step S23; Yes), or if the recovery point is exceeding the RPO requirement at step S25 (step S25; Yes), the management computer 300 subtracts the line bandwidth in the amount of the band fluctuation range designated in the line bandwidth calculation condition management table 325 (step S27).

For example, if the line bandwidth upper limit of 760 Mbps is set as the new line bandwidth provisional design value in the pair identifier 00, the value of 770 Mbps obtained by subtracting −10 Mbps from the band fluctuation range will become the new line bandwidth provisional setting value.

If a capacity value that is different from the capacity value adopted at step S23 is registered in the capacity calculation condition management table 326 (step S28; Yes), the management computer 300 changes the capacity value in this processing flow to the different capacity value that was registered (step S29), and once again performs the processing of steps S22 onward.

For example, in the case of the pair identifier 00, a capacity value other than the capacity value 1000 MB adopted at step S23 is not registered in the capacity calculation condition management table 326. Meanwhile, in the case of the pair identifier 01, if the capacity value adopted at step S23 is 800 MB, other capacity values 1000 MB, 1200 MB are also registered. In the foregoing case, the management computer 300 changes the capacity value to the other capacity value of 1000 MB or 1200 MB, and once again performs the processing of steps S22 onward.

If no other capacity value is registered in the capacity calculation condition management table 326 (step S29; No), the management computer 300 decides the line bandwidth and the capacity value at such point in time as the evaluated value of this processing (step S30), and thereafter ends this processing.

Nevertheless, when deciding the evaluated value of this processing, a value obtained by multiplying a given safety factor to the line bandwidth and the capacity value may also be used as the evaluated value.

The calculation method of the update data accumulation amount at step S22 and the recovery point at step S24 is now explained.

Foremost, the update data accumulation amount CC_{TT} accumulated in the update data storage area 121 at a certain time T is calculated according to Formula (1) below.

[Formula 1]

C_{T}=C_{T-1}+I_{T}−O_{T} (1)

C_{T-1}, is the update data accumulation amount at data acquisition time T−1 previous to time T. I_{T} corresponds to the input amount of the update data accumulated at time T in the update data storage area 121; in other words, I_{T} corresponds to the write data amount from the host computer 400. In this specification, for the sake of simplification, the size of management information associated with the update data is ignored, and it is deemed that the size of the update data and the size of the write data to be written from the host computer 400 coincide.

O_{T} represents the deletion amount of update data to be deleted as a result of the data copy program 132 transferring the update data accumulated in the update data storage area 121 to the storage apparatus 200 and completing the data transfer at time T.

O_{T} can be represented with Formula (2) below.

[Formula 2]

O_{T}=Min(B_{T},Pⱼ) (2)

B_{T} is the line bandwidth value provisionally designed at step S21. Pⱼ is the I/O performance of the update data storage area 121, and is acquired from the storage apparatus 100. The smaller value of either B_{T} or Pⱼ is used as O_{T}.

Here, the foregoing input amount I_{T} of the update data may also be a value defined by Formula (3) and Formula (4) below.

[Formula 3]

I_{T}=Min(W_{T}+W′_{T-1},Pⱼ,V−C_{T-1}) (3)

[Formula 4]

W′_{T}=(W_{T}+W′_{T-1})−I_{T} (4)

V is the capacity of the update data storage area 121.

Moreover, W_{T} signifies the write data amount received from the host computer 400 at time T W′_{T} is the residual update data amount that is stored in a temporary storage area such as a cache without being written into the update data storage area 121 at time T, and is calculated according to Formula (4).

Pⱼ represents the I/O performance showing the performance of data to be input to and output from the update data storage area 121. As the value of Pⱼ, the performance information of the update data storage area 121 accumulated in the performance information management table 136A concerning the update data storage area 121 described later with reference to FIG. 4 may be used.

Like this, the smallest value among W_{T}+W′_{T-1}, Pⱼ and V-C_{T-1}, may be used as I_{T}.

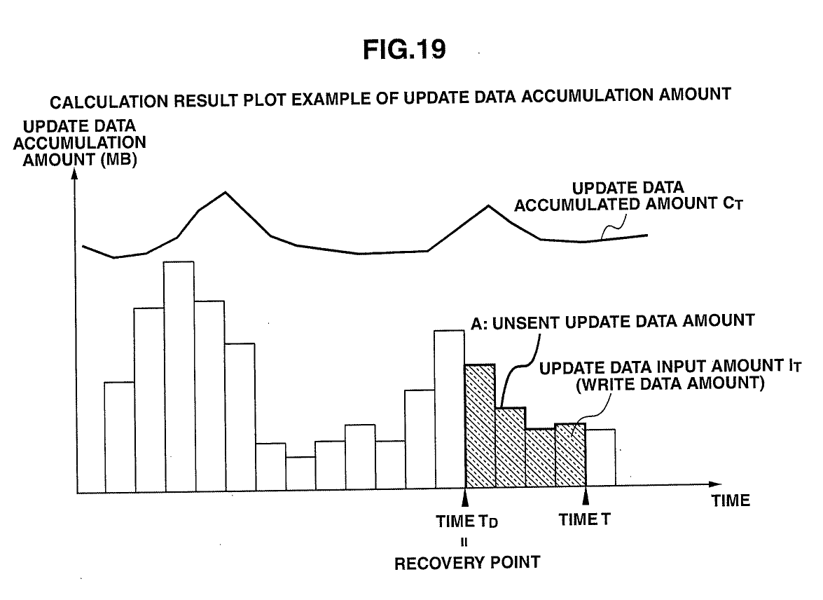

A graph showing the results of plotting the update data accumulation amount C_{T} and the update data input amount (write data amount) I_{T} at given time intervals is shown in FIG. 19. The graph of FIG. 19 shows the update data accumulation amount along the vertical axis and the time along the horizontal axis. The bar graph shown in FIG. 19 shows the write data amount acquired at the data acquisition time intervals, and the sequential line graph shows the update data accumulation amount.

Here, in order to calculate the recovery point at time T, the write data amounts I_{T}, I_{T-1} . . . are totaled retroactively from time T, and time T_{D} in which the total value of the write data amount reached the update data accumulation amount C_{T} of time T is sought. The recovery point at time T will be time T_{D}. In other words, at time T, the total value (indicated as frame A in FIG. 19) of the write data amount from time T_{D} to time T will be the update data amount that has not yet been sent to the storage apparatus 200.

For example, if the update data accumulation amount C_{T} is 100 MB, in order to calculate the recovery point at time T, the update data input amounts (write data amounts) I_{T} acquired at the data acquisition time intervals are totaled retroactively from time T, and time T_{D} in which the total value of the update data input amount (total value of the unsent update data input amount) reaches 100 MB will become the recovery point.

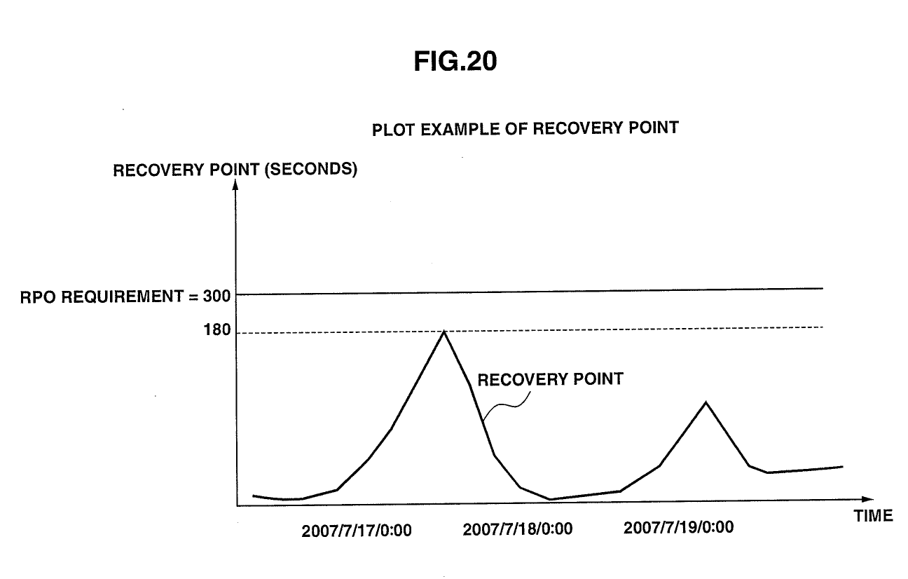

A graph showing the results of plotting the recovery point sought in the data acquisition time intervals along a time-series is shown in FIG. 20. The graph of FIG. 20 shows the recovery point along the vertical axis and the time along the horizontal axis. In the example of FIG. 20, the recovery point changes with time, and the maximum value (peak value) thereof is 180 seconds, or 3 minutes. The graph shows that the recovery point plotted along a time-series is constantly lower than the RPO requirement of 300 seconds (5 minutes) pre-set in the RPO requirement management table 327, and satisfying the RPO requirement.

A specific simulation example in an embodiment of the present invention that is realized by employing the foregoing programs and tables is explained below.

### (1-4) Specific Examples

When a remote copy configuration determination request is issued via the input device of the management computer 300, a monitoring data acquisition request is issued from the management computer 300 to the storage apparatus 100. The monitoring data acquisition request indicates a monitoring target data storage area identifier of “00:01”, a monitoring period of 2 days, and a value of 15 minutes as the data acquisition time interval.

Monitoring data in the monitoring period refers to the write data amount acquired at the data acquisition time intervals. Monitoring data is sent to the management computer 300 for each monitoring data acquisition, or after the completion of the monitoring period. The storage apparatus 100 simultaneously sends information concerning the pair configuration of the data storage area “00:01” to the management computer 300. In other words, the storage apparatus 100 sends the configuration information of the pair identified with the identifier “00” as the pair containing the data storage area “00:01.”

The data analysis program 323 in the management computer 300 performs the following simulation based on the monitoring data.

Step S21: Set Line Bandwidth Provisional Design Value

When referring to the line bandwidth calculation condition management table 325, the line bandwidth lower limit of the pair identified with the identifier “00” is 20 Mbps, the upper limit is 800 Mbps, and the band fluctuation range is −10 Mbps. Since the value of the fluctuation range is negative, the initial value is set to the upper limit of 800 Mbps, and 10 Mbps is subtracted from the line bandwidth provisional design value each time in the subsequent flow onward.

Step S22: Calculate Update Data Accumulation Volume Based on Line Bandwidth Provisional Design Value

The management computer 300 calculates the update data accumulation amount according to Formula (1) described above for each time the monitoring data is acquired.

Step S23: Compare Update Data Accumulation Volume and Update Data Storage Area Capacity

When referring to the capacity calculation condition management table 326, the capacity registered in the uppermost row as the capacity of the pair identifier “00” is 1000 MB. For example, if the peak value of the update data accumulation amount calculated at step S22 is 800 MB, since the update data accumulation amount will be lower than the foregoing capacity, the subsequent recovery point is calculated.

Step S24: Calculate Recovery Point

The management computer 300 calculates the recovery point each time the monitoring data is acquired. The calculation method of the recovery point is as explained above with reference to FIG. 19.

Step S25: Compare Calculated Recovery Point and RPO Requirement

When referring to the RPO requirement management table 327, the recovery requirement of the pair identified with the identifier “00” is 300 seconds.

For example, if the peak value of the recovery point calculated at step S24 is 280 seconds, this means that the recovery point will constantly satisfy the RPO requirement during the monitoring period.

Step S26 to Step S30: Calculate Next Line Bandwidth Provisional Setting Value

The management computer 300 calculates the next line bandwidth provisional setting value using the line bandwidth obtained by adding the bandwidth designated in the line bandwidth calculation condition management table 325 to the provisional design value. In the example of the line bandwidth calculation condition management table 325 shown in FIG. 8, since the band fluctuation range of the pair identified with the identifier “00” is “−10 Mbps,” the next line bandwidth provisional design value can be represented with Formula (5) below.

[Formula 5]

800 Mbps−10 Mbps=790 Mbps (5)

As a result of repeating this kind of simulation and calculating the update data accumulation amount when the line bandwidth provisional design value is 740 Mbps, it is assumed that the value exceeded the update data storage area capacity of 1000 MB. Since a separate capacity to the pair identified with the identifier “00” is not registered in the capacity calculation condition management table 326, the determined value of the line bandwidth can be represented with Formula (6) below.

[Formula 6]

740 Mbps−(−10 Mbps)=750 Mbps (6)

The foregoing explanation was an example of the simulation result.

Step S16: Output Evaluation and Determination Result to Management Screen

Subsequently, the management computer 300 outputs the simulation result example to the management screen or the like.

Step S17: Send Configuration Setting Request

The management computer 300 sends a configuration setting request to the storage apparatus 100. As the configuration setting request, for instance, a value that is greater than Formula (7) below of converting the line bandwidth determined value of 750 Mbps obtained in the foregoing simulation into the unit of MB/s as the request performance value.

[Formula 7]

750 Mbps/8 bit=93.75 MB/s (7)

This is because, in order to maximize the utilization of an expensive line that is used as the copy network, it is desirable to sufficiently secure the performance of resources in the storage apparatus that is cheaper than the line.

### (1-5) Effect of First Embodiment

As described above, according to the first embodiment, it is possible to decide the smallest possible line bandwidth for remote copy in a range that satisfies the RPO requirement.

### (2) Second Embodiment

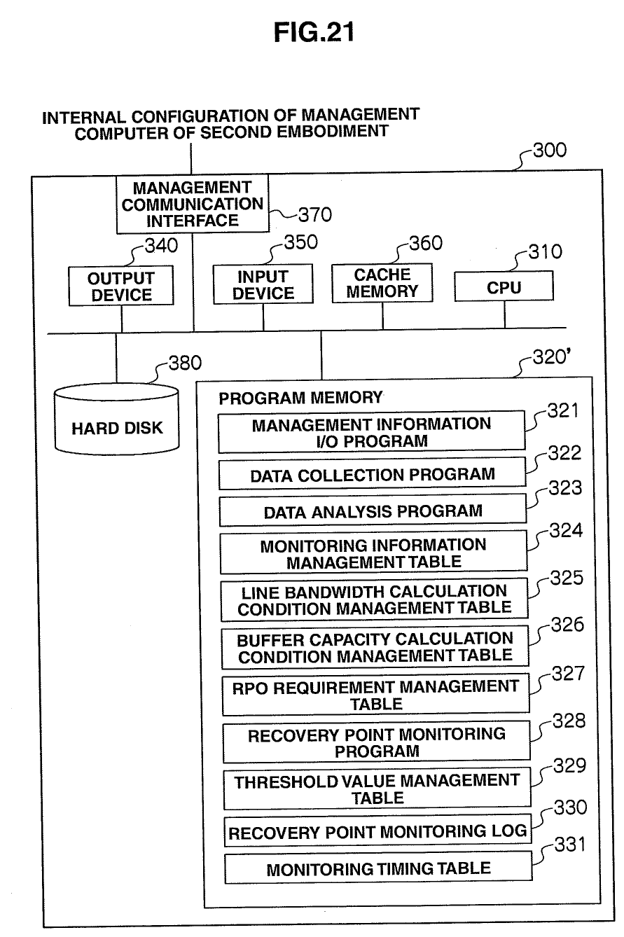

The second embodiment of the present invention is now explained with reference to FIG. 21 to FIG. 25.

The objective of the second embodiment is to monitor, in the computer system 1′ shown in FIG. 1 after the start of operation, whether the recovery point that satisfies the RPO requirement is being maintained and, if not, whether to notify the administrator or send a configuration change request from the management computer 300 to the storage apparatus 100.

In the following second embodiment, the difference in comparison to the first embodiment will be mainly explained. The connection configuration of the computer system 1′ of this embodiment may be the same as the computer system 1 illustrated in FIG. 1. Further, the internal configuration of the storage apparatus 100 may also be the same as the first embodiment depicted in FIG. 2. In addition, the reference numerals that are the same as the reference numerals of the first embodiment are the same as the first embodiment, and the explanation thereof is omitted.

(2-1) Internal Configuration of Management Computer

The internal configuration of the management computer 300 is now explained with reference to FIG. 21.

The internal configuration of the management computer 300 may be the same as the management computer 300 explained in the first embodiment shown in FIG. 6 excluding the programs and tables described below, and the explanation of the redundant portions are omitted.

The program memory 320′ additionally retains a threshold value management table 328, a recovery point monitoring program 329, a recovery point monitoring log 330, and a monitoring timing table 331.

The recovery point monitoring program 328 continuously calculates the recovery point value, and constantly monitors whether the calculated recovery point value is exceeding the RPO requirement.

The threshold value management table 329 retains criterion information concerning the operation of the computer system 1′ when a recovery point value that does not satisfy the RPO requirement is detected in the operating computer system 1′.

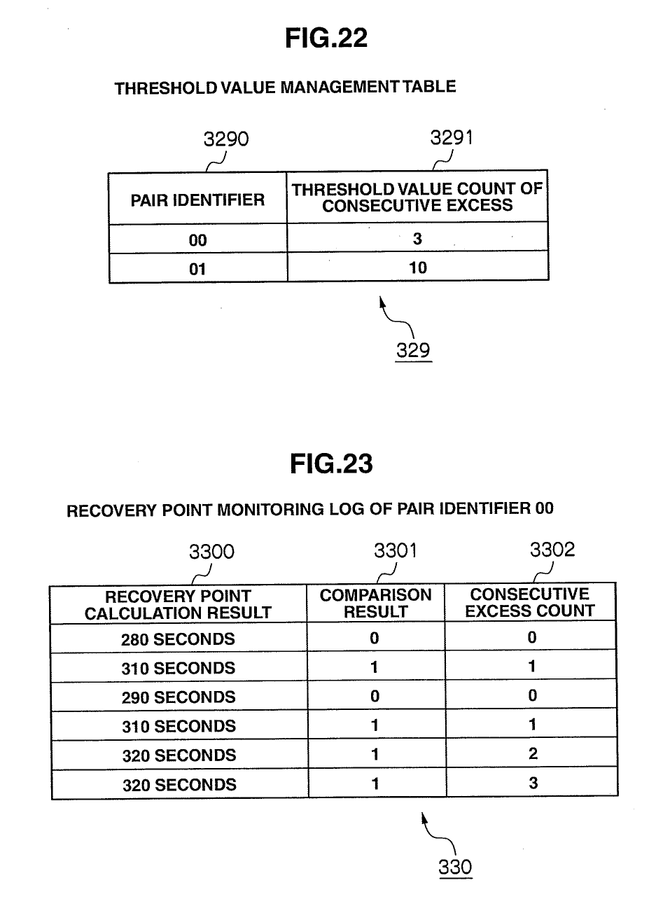

An example of the threshold value management table 329 is shown in FIG. 22. The threshold value management table 329 includes a field 3290 for recording a pair identifier of the monitoring target, and a field 3291 for registering the threshold value count in which the recovery point value consecutively exceeds the RPO requirement. In this embodiment, if the recovery point value consecutively exceeds the RPO requirement beyond the count registered in the threshold value count field 3291, the management computer 300 is set to transmit an alert to the administrator.

For example, as shown in FIG. 22, in the case of the pair identifier 00, if the recovery point value consecutively exceeds the RPO requirement three times or more, an alert is transmitted to the administrator.

The threshold value management table 329 is merely an example, and there is no particular limitation in the unit to be used in setting the threshold value or the value and unit to be used in the threshold value. For example, the field 3291 may be the time (seconds, minutes, hours, etc.) that the recovery point value consecutively exceeded the RPO requirement.

In this embodiment, although the “number of times that the recovery point value consecutively exceeded the RPO requirement” is set as the threshold value, in another embodiment, the “number of times that the recovery point value satisfied the RPO requirement and the time thereof” may be set as the threshold value and notifies to the user. In the foregoing case, the user will be able to recognize that the computer system 1′ is constantly satisfying the RPO requirement in a sufficient manner, and the line bandwidth or another resource can be reduced.

The recovery point monitoring log 330 is a log that is recorded for each pair identifier, and records information concerning the recovery point calculation result of the recovery point monitoring program 328.

An example of the recovery point monitoring log is shown in FIG. 23. The recovery point monitoring log 330 includes a field 3300 for recording the calculation result of the recovery point value calculated with the recovery point monitoring program 328, a field 3301 for comparing the recovery point value and the RPO requirement and recording the result, and a field 3302 for recording the number of times that the RPO requirement was consecutively exceeded.

Although the field 3301 of FIG. 23 records “0” when the recovery point calculation result does not exceed the RPO requirement and records “1” when the recovery point calculation result exceeds the RPO requirement, different values may be used so as long as the difference between the two is clear.

The monitoring timing table 331 sets the time interval for monitoring the recovery point value for each pair identifier.

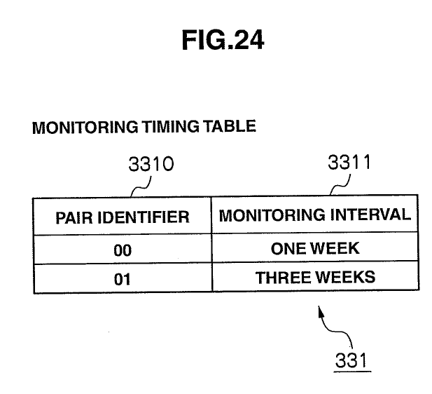

An example of the monitoring timing table 331 is shown in FIG. 24. The monitoring timing table 331 includes a field 3310 for recording the pair identifier of the monitoring target, and a field 3311 for setting the interval time for monitoring the recovery point value. For example, in the case of the pair identifier 00, whether the recovery point value exceeds the RPO requirement is monitored in one-week intervals.

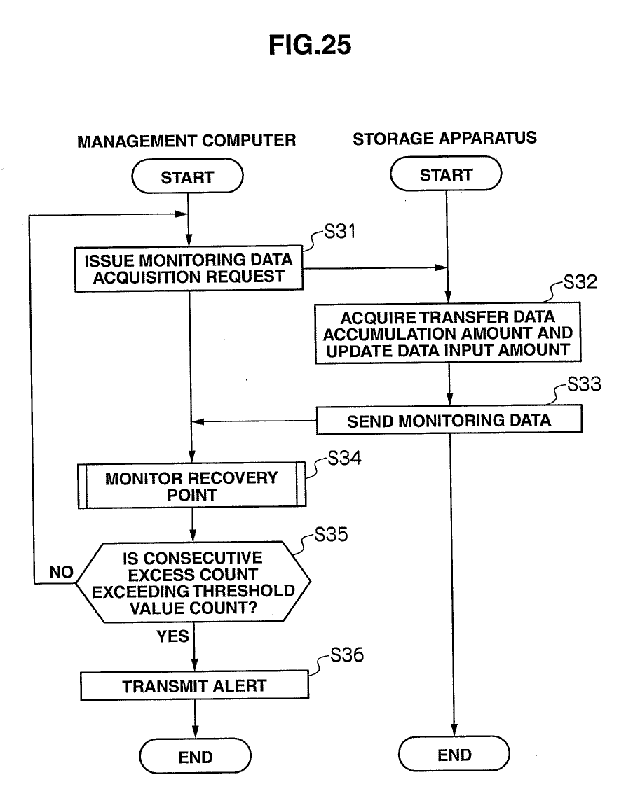

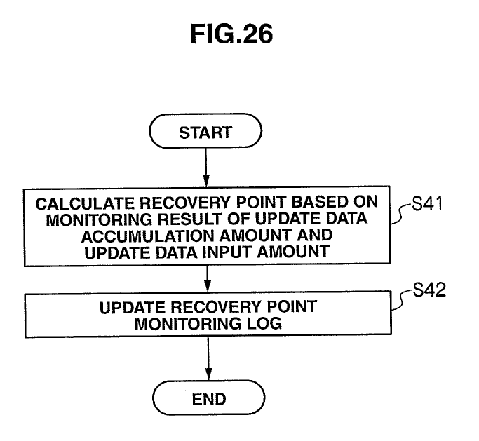

As a result of employing the computer system 1 described above, it is possible to operate the computer system so that it is constantly satisfying the RPO requirement. The operation method of this embodiment is now explained with reference to FIG. 25.

(2-2) Monitoring Operation Processing

FIG. 25 shows the flow of the sequential monitoring operation processing in this embodiment.

Foremost, the management computer 300 executes the data collection program 322 with the CPU 310, and issues a monitoring data acquisition request to the storage apparatus 100 (step S31). The monitoring data acquisition request indicates the data acquisition time interval designated in the monitoring information management table 324.

When the management computer 300 receives the monitoring data acquisition request, the storage controller 160 of the storage apparatus 100 executes the management information I/O program 131, and sends the monitoring data acquisition request to the data I/O monitoring program 133. The data I/O monitoring program 133 acquires the update data accumulation amount and the update data input amount (write data amount) to be actually accumulated in the cache memory 140 at the data acquisition time interval indicated in the monitoring data acquisition request (step S32). Although the update data accumulation amount CT was calculated in the first embodiment, the actual accumulation amount is acquired in this embodiment.

The storage apparatus 100 thereafter sends the acquired update data accumulation amount CT and the information concerning the pair configuration managed in the pair configuration management table 135 to the management computer 300 (step S33).

When the management computer 300 receives the update data accumulation amount CT, it activates the recovery point monitoring program 328, and calculates the recovery point value (step S34). The processing contents of the recovery point monitoring program 328 will be described later.

When the recovery point monitoring program 328 updates the recovery point monitoring log 330 based on the calculation result, the management computer 300 compares the number of times that the RPO requirement was actually exceeded consecutively, and the threshold value count (step S35).

If the management computer 300 determines that the number of times that the RPO requirement was actually exceeded consecutively does not exceed the threshold value count (step S35; No), it executes step S31 once again and continues the monitoring.

Meanwhile, if the management computer 300 determines that the number of times that the RPO requirement was actually exceeded consecutively exceeds the threshold value count (step S35; Yes), it transmits an alert to the user via the output device 340 (step S36).

After the management computer 300 transmits this alert, it is also possible to execute step S15 to step S18 explained in the first embodiment and re-determine the line bandwidth. Further, even when a change in setting in the pair configuration or the like is detected in the information concerning the pair configuration that the management computer 300 received from the storage apparatus 100, it is also possible to execute step S15 to step S18 explained in the first embodiment and re-determine the line bandwidth. The method of calculating the line bandwidth in the foregoing cases may be the same as the first embodiment.

(2-3) Monitoring Processing

The monitoring processing contents of the recovery point monitoring program 328 are now explained.

When the management computer 300 receives the update data accumulation amount CT, it actives the recovery point monitoring program 328, and calculates the recovery point value from the monitoring result based on the update data accumulation amount CT and the update data input amount (write data amount) IT from the host computer 400 (step S41). The method of calculating the recovery point value is the same as the first embodiment, and the explanation thereof is omitted.

Subsequently, the management computer 300 compares the calculation result of the recovery point value and the RPO requirement, and updates the comparison result field 3301 of the recovery point monitoring log 330. Based on this comparison result, the management computer 300 also updates the consecutive excess count field 3302 when the calculation result of the recovery point value consecutively exceeds the RPO requirement (step S42), and then ends this processing flow.

Although the monitoring operation processing and the monitoring processing were explained as separate processing, the management computer 300 may execute both processes as a single monitoring process.

### (2-4) Specific Examples

The embodiment of the present invention that is realized using the programs and tables described above are explained below with reference to specific examples.

When the copy operation by the data copy program 132 is started in the computer system 1′, the management computer 300 issues a monitoring data acquisition request to the storage apparatus 100. When employing the example described above, the monitoring data acquisition request indicates at least a monitoring target data storage area identifier of “00:01”, and a data acquisition time interval value of 15 minutes. The difference in comparison to the monitoring data acquisition request of the first embodiment is that the monitoring period is not indicated. The update data accumulation amount during the monitoring period is sent to the management computer 300 each time the update data accumulation amount is acquired, or after the lapse of a given period of time. The storage apparatus 100 simultaneously sends information concerning the pair configuration in the data storage area of “00:01” to the management computer 300. In other words, the storage apparatus 100 sends configuration information of the pair identified with the identifier “00” as the pair including the data storage area “00:01.”

Subsequently, the recovery point monitoring program 328 calculates the recovery point value and updates the recovery point monitoring log. For example, when using the example of the recovery point monitoring log shown in FIG. 23, it is evident that the number of times that the recovery point value of the pair identifier “00” exceeded 300 seconds, which is the RPO requirement recorded in the RPO requirement management table 327, has reached three times. According to the example of the threshold value management table 329 illustrated in FIG. 22, since the threshold value of the consecutive excess count of the pair identifier “00” is three times, at this point in time the management computer 300 sends an RPO requirement excess alert to the user.

Although several embodiments of the present invention have been explained above, these embodiments are exemplified for the purpose of explaining this invention, and are not intended to limit the scope of this invention in any way. The present invention can be implemented according to various other types of modes.

### (2-5) Effect of Second Embodiment

As described above, according to the second embodiment, it is possible to maintain the smallest possible remote copy line bandwidth in a range that satisfies the RPO requirement.

The present invention can be broadly applied to one or more computer systems, or computer systems of various other modes.

What is claimed is:

1. A computer system comprising a primary storage system having a primary update data storage area for temporarily storing update data from a host computer, a secondary storage system for asynchronously storing copy data of said update data in a secondary update data storage area pair-configured with said primary update data storage area, and a management computer for managing said primary storage system or said secondary storage system, wherein said primary storage system and said secondary storage system are connected via a copy network, and said primary storage system and said secondary storage system and said management computer are connected via a management network;
said computer system further comprises:
a measurement unit for measuring an update data input amount to be input into said primary update data storage area;
a calculation unit for calculating a recovery point in each given period of time based on the measured update data input amount and the band of said copy network; and
a comparison unit for comparing the calculated recovery point and a target recovery point to be pre-set as a target value for recovering said update data.

2. A computer system comprising a primary storage system having a primary update data storage area for temporarily storing update data from a host computer, a secondary storage system for asynchronously storing copy data of said update data in a secondary update data storage area pair-configured with said primary update data storage area, and a management computer for managing said primary storage system or said secondary storage system, wherein said primary storage system and said secondary storage system are connected via a copy network, and said primary storage system and said secondary storage system and said management computer are connected via a management network;
said computer system further comprises:
a recovery point calculation unit for calculating, as a recovery point of said update data at an arbitrary time, a coinciding time in which an update data accumulation amount of said update data accumulated in said primary update data storage area at said arbitrary time coincides with the total amount of update data input into said primary update data storage area; and
a recovery point comparison unit for comparing a recovery point calculated in a time-series at designated time intervals with said recovery point calculation unit and a target recovery point pre-set with a target point for recovering said update data.

3. The computer system according to claim 2,
wherein said total amount of the input amount of said update data is the total amount of the input amount of said update data obtained by adding the input amount of said update data acquired at said designated time intervals from said arbitrary time retroactively along a time axis.

4. The computer system according to claim 2,
wherein said update data accumulation amount at said arbitrary time is calculated based on the update data accumulation amount accumulated in said primary update data storage area before said arbitrary time, the update data input amount input to said primary update data storage area at said arbitrary time, and the update data deletion amount deleted from said primary update data storage area at said arbitrary time.

5. The computer system according to claim 2, further comprising:
a line bandwidth decision unit for deciding a line bandwidth of said copy network for connecting said primary storage system and said secondary storage system based on the calculation result of said recovery point calculation unit for each pair of said primary update data storage area and secondary update data storage area.

6. The computer system according to claim 5,
wherein said line bandwidth decision unit adds a designated line bandwidth fluctuation range from an upper limit or a lower limit of the line bandwidth pre-set for each pair when said recovery point does not exceed said target recovery point, and subtracts a designated line bandwidth fluctuation range from an upper limit or a lower limit of the line bandwidth pre-set for each pair when said recovery point exceeds said target recovery point, and decides the line bandwidth of said network for each pair of said primary update data storage area and secondary update data storage area.

7. The computer system according to claim 6, further comprising:
a determination unit for determining the capacity of the storage area used as said data update storage area when said line bandwidth decision unit decides that said recovery point exceeds said target recovery point.

8. The computer system according to claim 2,
wherein the calculation result of said recovery point calculation unit is output to a management screen of said management computer.

9. The computer system according to claim 2, further comprising:
a monitoring unit for pre-setting a threshold value count in which said recovery point consecutively exceeds said target recovery point, managing the count in which said recovery point consecutively exceeds said target recovery point, and comparing the count in which said recovery point consecutively exceeds said target recovery point and said threshold value count and transmitting an alert when said recovery point consecutively exceeds said target recovery point.

10. A data loss prevention method of a computer system comprising a primary storage system having a primary update data storage area for temporarily storing update data from a host computer, a secondary storage system for asynchronously storing copy data of said update data in a secondary update data storage area pair-configured with said primary update data storage area, and a management computer for managing said primary storage system or said secondary storage system; wherein said primary storage system and said secondary storage system are connected via a copy network, and said primary storage system and said secondary storage system and said management computer are connected via a management network;
said data loss prevention method comprises:
a measurement step for measuring an update data input amount to be input into said primary update data storage area;
a calculation step for calculating a recovery point in each given period of time based on the measured update data input amount and the band of said copy network; and
a comparison step for comparing the calculated recovery point and a target recovery point to be pre-set as a target value for recovering said update data.

11. A data loss prevention method of a computer system in which a primary storage system having a primary update data storage area for temporarily storing update data from a host computer, a secondary storage system for asynchronously storing copy data of said update data in a secondary update data storage area pair-configured with said primary update data storage area, and a management computer for managing said primary storage system or said secondary storage system are connected via a network, comprising:
a recovery point calculation step for calculating, as a recovery point of said update data at an arbitrary time, a coinciding time in which an update data accumulation amount of said update data accumulated in said primary update data storage area at said arbitrary time coincides with the total amount of update data input into said primary update data storage area; and
a recovery point comparison step for comparing a recovery point calculated in a time-series at designated time intervals with said recovery point calculation unit and a target recovery point pre-set with a target point for recovering said update data.

12. The data loss prevention method according to claim 11,
wherein said total amount of the input amount of said update data is the total amount of the input amount of said update data obtained by adding the input amount of said update data acquired at said designated time intervals from said arbitrary time retroactively along a time axis.

13. The data loss prevention method according to claim 11,
wherein said update data accumulation amount at said arbitrary time is calculated based on the update data accumulation amount accumulated in said primary update data storage area before said arbitrary time, the update data input amount input to said primary update data storage area at said arbitrary time, and the update data deletion amount deleted from said primary update data storage area at said arbitrary time.

14. The data loss prevention method according to claim 11, further comprising:
a line bandwidth decision step for deciding a line bandwidth of said copy network for connecting said primary storage system and said secondary storage system based on the calculation result at said recovery point calculation step for each pair of said primary update data storage area and secondary update data storage area.

15. The data loss prevention method according to claim 14,
wherein, at said line bandwidth decision step, a designated line bandwidth fluctuation range is added from an upper limit or a lower limit of the line bandwidth pre-set for each pair when said recovery point does not exceed said target recovery point, and a designated line bandwidth fluctuation range is subtracted from an upper limit or a lower limit of the line bandwidth pre-set for each pair when said recovery point exceeds said target recovery point, and the line bandwidth of said network is decided for each pair of said primary update data storage area and secondary update data storage area.

16. The data loss prevention method according to claim 15, further comprising:
a determination step for determining the capacity of the storage area used as said data update storage area when said recovery point exceeds said target recovery point at said line bandwidth decision step.

17. The data loss prevention method according to claim 11,
wherein the calculation result at said recovery point calculation step is output to a management screen of said management computer.

18. The data loss prevention method according to claim 11, further comprising:
a monitoring step for pre-setting a threshold value count in which said recovery point consecutively exceeds said target recovery point, managing the count in which said recovery point consecutively exceeds said target recovery point, and comparing the count in which said recovery point consecutively exceeds said target recovery point and said threshold value count and transmitting an alert when said recovery point consecutively exceeds said target recovery point.
